(19) United States
(12) Patent Application Publication
(10) Pub. No.: US 2008/0212568 A1
(43) Pub. Date: Sep. 4, 2008

(54) WIRE AND WIRELESS INTERNET PHONE TERMINAL USING WIDEBAND VOICE CODEC

(75) Inventors: Woon Seob So, Daejeon (KR); Do Young Kim, Daejeon (KR); Hae Won Jung, Daejeon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon (KR)

(21) Appl. No.: 11/948,956

(22) Filed: Nov. 30, 2007

(30) Foreign Application Priority Data
Dec. 1, 2006 (KR) 10-2006-0120372
Jul. 3, 2007 (KR) 10-2007-0066783

(51) Int. Cl. H04L 12/66

(52) U.S. Cl. 370/352

(57) ABSTRACT

A wire/wireless Internet phone terminal using a wideband voice codec is provided. The wire/wireless Internet phone terminal using a wideband voice codec includes: a multimedia application processor for including a process core to perform a protocol according to a wire and wireless interface communication scheme and supporting wideband voice service; an Ethernet processing unit for connecting the multimedia application processor to the Ethernet to perform an Ethernet physical-layer function of and transforming a power input from the Ethernet to supply a driving power to the multimedia application processor; a PSTN (public switched telephone network) processing unit for connected to the multimedia application processor and a PSTN to emulate a telephone function; and a wireless processing unit for connecting the multimedia application processor to an AP (access point) in a wireless manner. Accordingly, it is possible to provide a wideband service without a limitation to wire/wireless implementation.

### CROSS-REFERENCE TO RELATED APPLICATIONS

This application claims the priorities of Korean Patent Application No. 10-2007-66783 filed on Jul. 3, 2007 and No. 10-2006-120372 filed on Dec. 1, 2006, in the Korean Intellectual Property Office, the disclosure of which is incorporated herein by reference.

### BACKGROUND OF THE INVENTION

1. Field of the Invention

The present invention relates to a wire/wireless Internet phone terminal using a wideband voice codec, and more particularly, to a wire/wireless Internet phone terminal using a wideband voice codec capable of providing an Internet phone function and a multimedia Internet access function free of charge or at a low fee via the world wide Internet.

This work was supported by the IT R&D program of MIC/IITA [2005-S-100-02, Development of Multi-codec and Its Control Technology Providing Variable Bandwidth Scalability].

2. Description of the Related Art

Current communication terminals using the Internet are divided into a wireless Internet phone communication terminal and a wire Internet phone communication terminal using Bluetooth or a wireless local area network (LAN). The two types of communication terminals are separately operated and used, so that there is a limitation to implement the communication terminals.

In addition, these communication terminals are constructed with narrow band voice codec and devices for supporting only the narrow band.

Therefore, the current communication terminals have a limitation to wire/wireless implementation. In addition, since the current communication terminals are implemented in only the narrow band, there is a problem of implementing high-quality communication terminals. For example, the current communication terminal cannot provide a voice or sound in a band of 6 kHz such a cricket's chirping sound other than a human voice.

### SUMMARY OF THE INVENTION

An aspect of the present invention provides a wire/wireless Internet phone terminal using a wideband voice codec capable of implementing a high-quality communication terminal in wire/wireless manner without a limitation to a narrow band and providing a wideband service without a limitation.

According to another aspect of the present invention, there is provided a wire/wireless Internet phone terminal using a wideband voice codec, comprising: a multimedia application processor for including a processor core to perform a protocol according to a wire and wireless interface communication scheme and supporting wideband voice service; an Ethernet processing unit for connecting the multimedia application processor to the Ethernet to perform an Ethernet physical-layer function of and transforming a power input from the Ethernet to supply a driving power to the multimedia application processor; a PSTN (public switched telephone network) processing unit for connected to the multimedia application processor and a PSTN to emulate a telephone function; and a wireless processing unit for connecting the multimedia application processor to an AP (access point) in a wireless manner.

In the above aspect of the present invention, the Ethernet processing unit may comprise: an Ethernet physical-layer processing unit for performing the Ethernet physical-layer function by connecting the multimedia application processor to the Ethernet; and an Ethernet power supply unit for connected to the Ethernet to transform the power input from the Ethernet and supplying the driving power to the multimedia application processor as the driving power. In addition, the wireless processing unit may comprise: a USB (universal serial bus) host accessing unit for connected to the multimedia application processor and a USB port to perform a host accessing function of a USB apparatus; and a wireless access module for connected to the USB host port to perform an AP accessing function in a wireless manner.

In addition, the wire/wireless Internet phone terminal may further comprise a wideband transceiver input/output unit for connected to the multimedia application processor to perform a wideband transceiver input/output function.

In addition, the wideband transceiver input/output unit may be constructed with a microphone, a speaker, and a transceiver which inputs and outputs a voice signal in a wideband of 50 Hz to 7 kHz without attenuation.

In addition, the wire/wireless Internet phone terminal may further comprise at least one of: an EIA232 accessing unit for connected to the multimedia application processor to access a terminal for debugging; a USB OTG (on-the-go) accessing unit for connected to the multimedia application processor and a USB OTG port to perform an accessing function of accessing an USB OTG device; a JTAG (joint test action group) accessing unit for connected to the multimedia application processor to connect the multimedia application processor to other debugging apparatuses; a reset unit for providing a reset signal required for the multimedia application processor; a clock unit for providing a clock signal required for the multimedia application processor; a memory unit for connected to the multimedia application processor to store a start program, a terminal apparatus operating program, a user data, and a plurality of application programs; a camera input unit for connected to the multimedia application processor to receive an input of video information from a user; a CLCD (color LCD) output unit for connected to the multimedia application processor to output a video and information required for the user; a TV output controller for connected to the multimedia application processor to output a video and information required for the user on a TV; and a keypad input unit for connected to the multimedia application processor to receive an input of control information from the user.

In addition, the multimedia application processor may comprise: a processor core unit for including an ARM core to perform a function of controlling the wire/wireless Internet phone terminal using the wideband voice codec; a user accessing unit for performing an input and output function for the user; and a network accessing unit for performing a function of connecting to a network.

In addition, the processor core unit may comprise: a reset controller for controlling a reset signal to be connected to an internal bus connected to the ARM core; a clock controller for controlling a clock signal; a memory interface controller for performing an accessing function of accessing an external memory; a DMA (direct memory access) controller for controlling data reception and transmission between controllers and memories without interruption of a processor; an interrupt controller for processing an interrupt; a WD (watch dog) timer for generating the interrupt in a predetermined time period; a general timer for receiving an input of a reference clock and generates a suitable timing signal at a predetermined time; an RTC (real-time clock) for counting a clock of 1 Hz in a second unit to calculate minute, hour, day, month, and year; a bus controller for connecting a data signal, an address signal, and a control signal to one of multiple buses in accordance with a timing of each bus; and a bus matrix switch for performing high-speed bus switching between multiple master buses and multiple slave buses.

In addition, the user accessing unit may comprise: an AC (audio codec) '97 controller for connected to the internal bus to receive and transmit 8-bit or 16-bit sampled voice or audio PCM (pulse code modulated) data; a CLCD controller for generating and controlling a CLCD data, a synchronization data, and a clock signal; a camera controller for receiving an input of a video source in an CCIR656 (international radio consultative committee 656) format and a CMOS (complementary metal oxide semiconductor) sensor from an external and processing the video source; a keypad controller for performing scanning of a keypad matrix connected externally; a UART (universal asynchronous receiver/transmitter) controller for controlling asynchronous input and output data; and a multimedia accelerator for performing pre-processes and post-processes on input and output image data and encoding or decoding the video data according to a video codec standard.

In addition, the network accessing unit may comprise: an USB OTG controller for connected to the internal bus to process a date which access the USB OTG port; a USB host controller for processing a data which accesses the USB host port; an SSI (synchronous serial interface) controller for processing a data which is inputted and outputted in series by synchronization with a clock; and an Ethernet MAC (media access controller) for performing an Ethernet MAC function.

In the wire/wireless Internet phone terminal using a wideband voice codec according to the present invention, the multimedia application processor is constructed by integrating functions necessary for an Internet phone, so that it is possible to minimize the number and components and sizes thereof and to easily design and construction of the wire/wireless Internet phone terminal.

In addition, the wire/wireless Internet phone terminal using a wideband voice codec according to the present invention, wire/wireless Internets are cooperatively used, so that it is possible to access the Ethernet at a low cost and to freely access the Ethernet by using a wireless LAN in a case where wire access is not available.

In addition, in the wire/wireless Internet phone terminal using a wideband voice codec according to the present invention, hardware and software having various functions can be additionally provided as needed, so that it is possible to implement a high-quality communication terminal having various uses.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating a configuration of an Ethernet environment for a wire/wireless Internet phone terminal using a wideband voice codec according to an embodiment of the present invention;

FIG. 2 is a schematic view illustrating a configuration of a wireless implementation for a wire/wireless Internet phone terminal using a wideband voice codec according to an embodiment of the present invention;

FIG. 3 is a view illustrating a configuration of a wire/wireless Internet phone terminal using a wideband voice codec according to an embodiment of the present invention; and

FIG. 4 is a view illustrating a configuration of a multimedia application processor according to an embodiment of the present invention;

### DETAILED DESCRIPTION OF THE PREFERRED EMBODIMENT

Hereinafter, exemplary embodiments of the present invention will now be described in detail with reference to the accompanying drawings. For clarifying of the present invention, description of well-known functions, structures, configuration, or constructions may be omitted.

In the accompanying drawings, like reference numerals denote like elements.

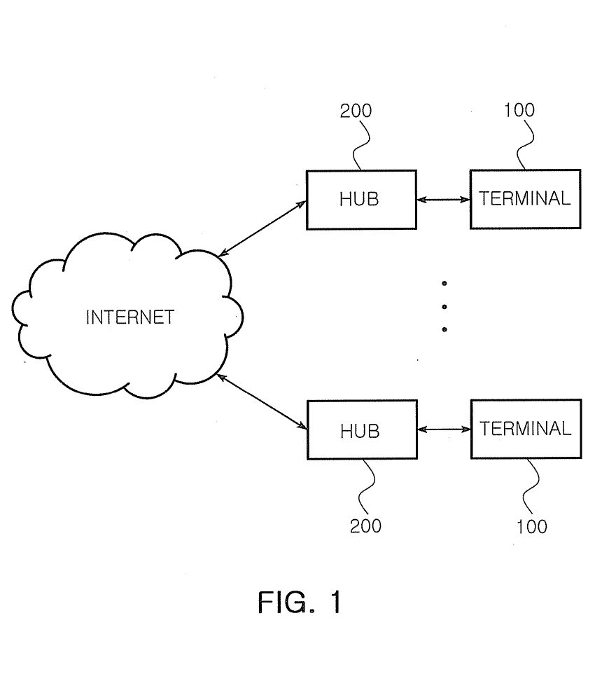

FIG. 1 is a schematic view illustrating a configuration of an Ethernet environment for a wire/wireless Internet phone terminal using a wideband voice codec according to an embodiment of the present invention.

Referring to FIG. 1, the wire/wireless Internet phone terminal 100 using wideband voice codec is connected to an Internet via hubs 200 in home or office with an Ethernet environment.

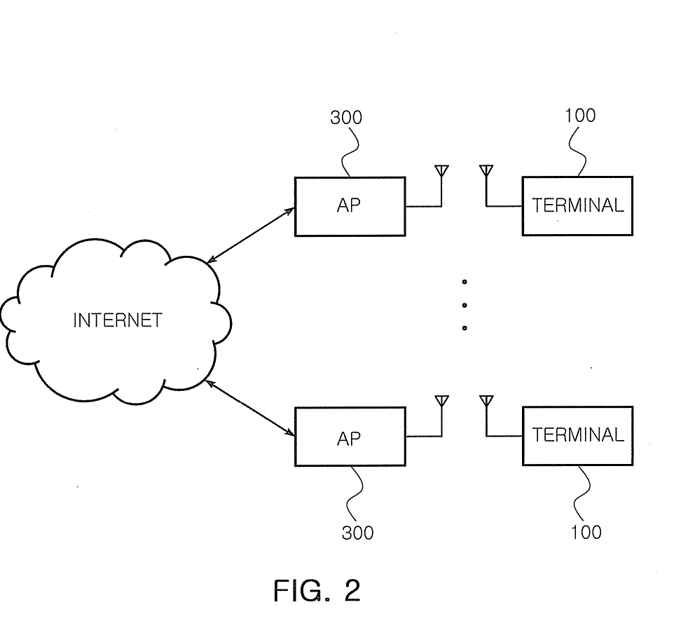

FIG. 2 is a schematic view illustrating a configuration of a wireless implementation for the wire/wireless Internet phone terminal 100 using a wideband voice codec according to an embodiment of the present invention.

Referring to FIG. 2, the wire/wireless Internet phone terminal 100 using a wideband voice codec is connected to access points (APs) 300 in a wireless manner.

The wire/wireless Internet phone terminal 100 using a wideband voice codec is directly connected to an Ethernet access apparatus such a hub 200 or accesses the APs 300 in a wireless manner so as to easily implement wire/wireless environments in home or office and provide an Ethernet or wireless-Internet voice phone function and an Internet access service function

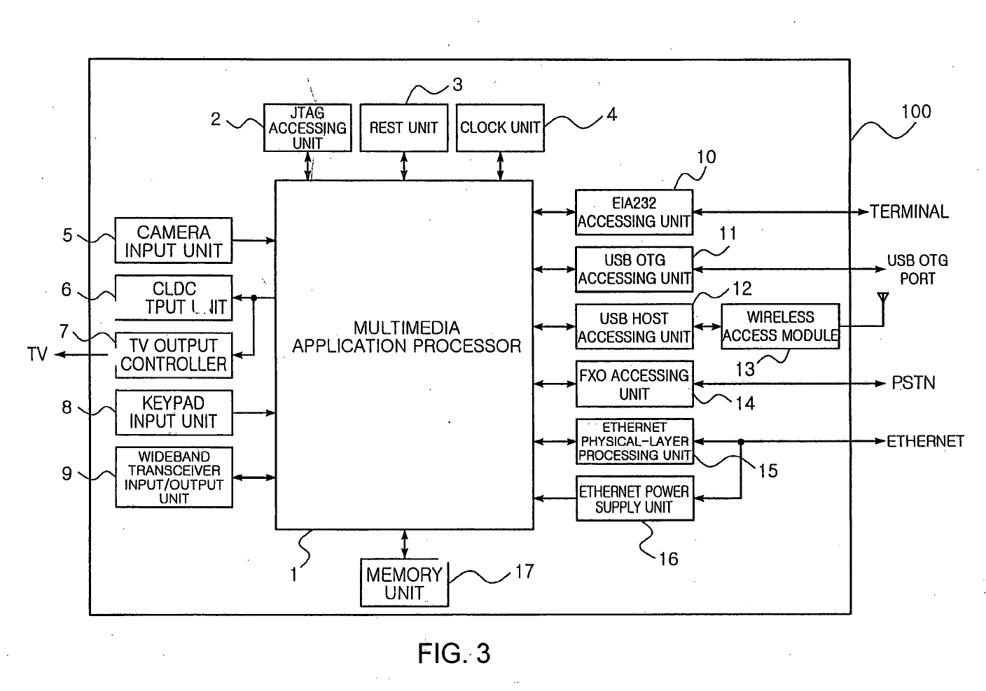

Now, a configuration of the wire/wireless Internet phone terminal 100 using a wideband voice codec capable of easily implementing wire/wireless environments is descried in detail with reference to FIG. 3.

FIG. 3 is a view illustrating a configuration of the wire/wireless Internet phone terminal 100 using a wideband voice codec according to the embodiment of the present invention.

Referring to FIG. 3, the wire/wireless Internet phone terminal 100 (hereinafter, referred to as a terminal) using a wideband voice codec includes a multimedia application processor 1, a joint test action group (JTAG) accessing unit 2 that is an interface for the terminal 100, a rest unit 3, a clock unit 4, a camera input unit 5, a color liquid crystal display (CLDC) output unit 6, a TV output controller 7, a keypad input unit 8, a wideband transceiver input/output unit 9, an EIA232 accessing unit 10, a universal-serial-bus (USB) on-the-go (OTG) accessing unit 11, a USB host accessing unit 12 and a wireless access module 13 for wireless processing, a foreign exchange office (FXO) accessing unit 14 for public switched telephone network (PSTN) processing, an Ethernet physical-layer processing unit 15 and an Ethernet power supply unit 16 for Ethernet processing, and a memory unit 17.

The multimedia application processor 1 has a processor core. The multimedia application processor 1 is connected to various components and performs protocol processes for the components according to communication schemes thereof and functions of the communication terminal 100 in a hardware or software manner.

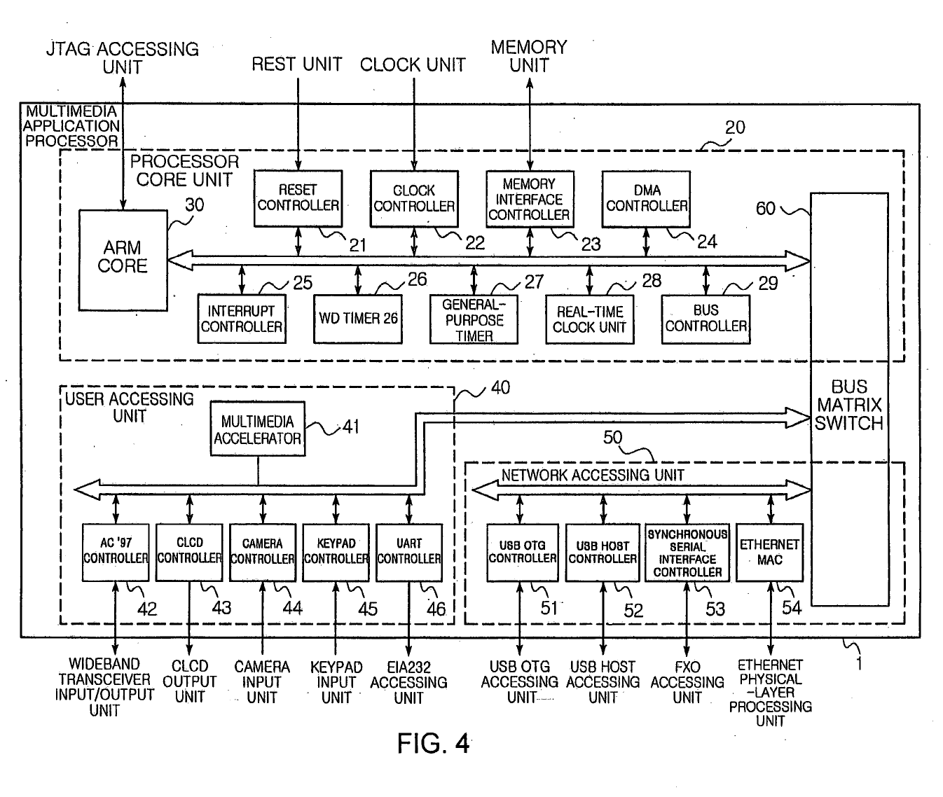

The JTAG accessing unit 2 is connected to an ARM core 30 in FIG. 4 for performing a JTAG control process function of the multimedia application processor 1. In addition, the JTAG accessing unit 2 may be connected to a debugging apparatus (not shown) such as a multi-in-circuit emulator (ICE), a realview-ICE, and an open-ICE so as to debug software programs operated in the processor core unit 20.

The JTAG accessing unit 2 receives and transmits debugging information from and to the multimedia application processor 1 by using an input data signal TDI, an output data signal TDO, a data clock signal TCK, a reset signal TRST, a mode selection signal TMS, and the like.

The reset unit 3 provides a power input reset signal and a switch reset signal to the multimedia application processor 1 in a predetermined time interval required for the multimedia application processor 1.

The clock unit 4 provides clocks required for the terminal 100, for example, a 26 MH clock and a 32.768 kHz clock to the multimedia application processor 1. The clocks that the clock unit 4 provides to the multimedia application processor 1 are divided or multiplied in the multimedia application processor 1 to be supplied to the internal components of the multimedia application processor 1. In addition, the clocks are used as a source for the real-time clock unit.

The camera input unit 5 receives a video image of a user through a color CMOS image sensor and provides the video image to the multimedia application processor 1.

The camera input unit 5 processes 8-bit camera data signals (CSD0 to CSD7), a camera data clock (CSCLK), a camera data strobe signal (CSSTRB), a camera data vertical synchronization signal (CSVSYNC), a camera data horizontal synchronization signal (CSHSYNC), a serial control data signal (SDATA), and a serial control data clock signal (SCLK) so as to be connected to cameras having various resolutions.

The CLCD output unit 6 is connected to the multimedia application processor 1 by using maximum-24-bit CLCD data signals (CLD0 to CLD23), a CLCD data clock (CLCLK), a CLCD data enable signal (CLDEN), a CLCD vertical synchronization signal (CLVSYNC), and a CLCD horizontal synchronization signal (CLHSYNC) to display all the states of the terminal 100, user-required messages, and video data. The messages displayed on the CLCD output unit 6 may include a current state of a phone, a calling phone number, a destination phone number, a current time, a current date, a current day of the week, a reception signal intensity, and the like. In addition, the CLCD output unit 6 may further include various messages which can be added or removed by programming the multimedia application processor 1.

TV output controller 7 converts digital video data output for the multimedia application processor 1 to a composite format, an S-video format, or a standard VGA format by using a digital-to-analog converting device.

Accordingly, the TV output controller 7 uses a composite port or an S-video port for connection to TV and a standard VGA port for connection to a PC monitor.

The keypad input unit 8 may includes 12 basic key buttons for dialing a phone number or special numbers and 16 function-key buttons for additional service function so as to be connected to the multimedia application processor 1. The function-key buttons may include a menu key, an enter key, a send key, an end key, a setting key, and the like.

The wideband transceiver input/output unit 9 is constructed with a microphone, a speaker, and a transceiver which can process a voice signal in a wide audible band of 50 Hz to 7 kHz. The wideband transceiver input/output unit 9 is connected to the multimedia application processor 1 to provide a wideband voice service to the user.

In general, it is difficult to implement a device for supporting a wideband for a receiver and a speaker of a transceiver. Therefore the wideband of the wideband transceiver input/output unit 9 is implemented by using two devices, that is, a low frequency band device and an intermediate-high frequency band device. The wideband transceiver input/output unit 9 provides audio codec for interconverting digital signals and analog signals with respect to various tone signals and audio signals. The wideband transceiver input/output unit 9 amplifies an analog signal suitable for the transceiver and microphone and speaker thereof.

The EIA232 accessing unit 10 is connected to the terminal via an EIA232 port for debugging. The EIA232 accessing unit 10 constitutes the transceiver to perform signal level conversion and drive. The EIA232 accessing unit 10 is connected to the multimedia application processor 1 to transmits and receive a transmission data signal (TXD) and a reception data signal (RXD).

The USB OTG accessing unit 11 is connected to a multimedia application processor 1 by using a USB OTG transceiver to receive and transmit input data signals (OVM and OVP), output data signals (OVMO and OVPO), a data enable signal (DE), an interrupt signal (INT), a serial data clock signal (SCL), a serial data signal (SDA). The USB OTG accessing unit 11 is connected to a USB OTG port to receive and transmit differential plus and minus data signals (ODP and ODM). Therefore The USB OTG accessing unit 11 performs a function for receiving and transmitting data. The USB OTG accessing unit 11 supports a device mode and a host mode unlike the USB host port. In addition, the USB OTG accessing unit 11 can support modes which are determined according to the ID-pin level of the USB port.

In the wireless processing unit, the USB host accessing unit 12 is connected to the multimedia application processor 1 to receive and transmit input data signals (VM and VP) and output data signal (VMO and VPO) by using the USB host transceiver. In addition, the USB host accessing unit 12 is connected to the USB host port to receive and transmit a differential plus data signal (DP) and a differential minus data signal (DM).

In the wireless processing unit, the wireless access module 13 is constructed as a USB module. The wireless access module 13 is connected to the USB host accessing unit 12 to receive and transmit the differential plus data signal (DP) and the differential minus data signal (DM). The wireless access module 13 process data in accordance with a wireless LAN protocol corresponding to an internally-used wireless interface to finally receive and transmit the wireless data from and to the AP 300 via an antenna.

The wireless access module 13 uses a wireless LAN standard such as IEEE802.11a/b/g/n and IEEE802.16.

The FXO accessing unit 14 which is a public switched telephone network (PSTN) processing unit is connected to tip and ring signals of a PSTN line to terminate the PSTN line. The FXO accessing unit 14 performs 2line-4line transformation to divide input and output analog signals and transforms the analog signals to PCM digital signals by using a narrow band codec, so that the FXO accessing unit 14 can be connected to the multimedia application processor 1. Therefore, the multimedia application processor 1 can emulate a general phone function by using the Internet phone terminal 100 so that the voice communication can be performed through the PSTN.

In the Ethernet processing unit, the Ethernet physical-layer processing unit 15 is connected to an Ethernet physical-layer processing device of the multimedia application processor 1 through a standard media independent interface (MII) to perform a physical-layer function.

The Ethernet physical-layer processing unit 15 is connected to the multimedia application processor 1 to receive and transmit transmission data signals (MTXD3 to MTXD0), a transmission-enable signal (MTXENB), a transmission data clock signal (MTXCLK), and a transmission error signal (MTXER). In addition, the Ethernet physical-layer processing unit 15 is connected to the multimedia application processor 1 to receive and transmit reception data signals (MRXD3 to MRXD0), a reception enable signal (MRXDVB), a reception data clock signal (MRXCLK), a reception error signal (MRXER), a carrier sense signal (MCRS), a collision detection signal (MCOL), an interrupt signal (MINTR), a control data clock signal (MDC), and a control data signal (MDIO). In addition, the Ethernet physical-layer processing unit 15 is connected to an Ethernet line to receive and transmit date through an output data plus signal (TPOP), an output data minus signal (TPOM), an input data plus signal (TPIP), and an input data minus signal (TPIM).

In the Ethernet processing unit, the Ethernet power supply unit 16 is connected to the Ethernet line according to a power over Ethernet (PoE) specification of the IEEE802.3af standard. The Ethernet power supply unit 16 receives an input power of 48V from four pins and transforms the input power to 12V, 5V, or 3.3V DC/DC power to supply the DC/DC powers to the terminal 100. Therefore, the terminal 100 needs not use a separate AC/DC power adaptor for supplying power.

The memory unit 17 is directly connected to the multimedia application processor 1 to store a start program and a terminal apparatus operating program.

The memory unit 17 is constructed with a flash read only memory (FROM) or a synchronization dynamic random access memory (SDRAM) which can be accessed via an 8-bit, 16-bit, or 32-bit bus to temporarily store a user data or various application programs. In addition, the memory unit 17 may be connected to an external device which can be accessed in a memory map scheme.

Now, a configuration of the multimedia application processor 1 of the wire/wireless Internet phone terminal 100 using a wideband voice codec is described in detail.

FIG. 4 is a view illustrating a configuration of a multimedia application processor 1 according to an embodiment of the present invention.

As shown in FIG. 4, in the wire/wireless Internet phone terminal 100 using a wideband voice codec, the multimedia application processor 1 includes a processor core unit 20, a user accessing unit 40, and a network accessing unit 50.

The processor core unit 20 of the multimedia application processor 1 may include an ARM core 30, a reset controller 21, a clock controller 22, a memory interface controller 23, a direct memory access (DMA) controller 24, an interrupt controller 25, a watch-dog (WD) timer 26, a general-purpose timer 27, a real-time clock unit 28, a bus controller 29, and a bus matrix switch 60. These components are connected to each other via an internal bus.

The ARM core 30 is a 32-bit RISC microprocessor including an instruction cache, a data cache, a memory management unit (MMU), and a JTAG control function. The ARM core 30 performs a central arithmetic process function for the entire multimedia application process 1.

The reset controller 21 is connected to the reset unit 3 to initialize all the circuits of the processor core unit 30 according to an externally input reset signal. In addition, the reset controller 21 generates reset signals required for other controllers and loads the reset signals on the bus.

The clock controller 22 is connected to the clock unit 4. The clock controller 22 converts a clock signal, for example, 26 MHz clock to various clocks for internal components of the processor core unit 20 by using a phase lock loop (PLL). In addition, the clock controller 22 provides an external-input clock, for example, 32.768 kHz clock to the real-time clock unit 28.

The memory interface controller 23 generates control signals for data-reading of a memory or data-writing on a memory at predetermined timings for connection to an externally-connected flash memory, a synchronization dynamic memory, or a memory-map type device.

The DMA controller 24 generates a control signal for rapidly performing data reception and transmission between controllers and memories without interruption of a processor and loads the control signal on the bus. The DMA controller 24 acquires a master right from the processor to transmit data.

The interrupt controller 25 processes internal and external interrupts generated during execution of a program according to a predetermined priority. The WD timer performs a periodic WD function for generating an interrupt for monitoring procedures of the program in a predetermined period.

The general-purpose timer 27 receives a reference clock and generates suitable timing signals at time set by the program. The real-time clock unit 28 performs frequency division using the reference clock, that is, 32.768 kHz clock and performs counter function in units of 1 Hz clock, that is, in units of second to calculate minute, hour, month, and year.

The bus controller 29 connects data signals, address signals, and control signals to one of multiple buses at the suitable timings of the buses. The bus matrix switch 60 performs high-speed switching between multiple master buses and multiple slave buses. Namely, the bus matrix switch 60 performs a function of switching the buses for the processor core unit 20, the user accessing unit 40, and the network accessing unit 50.

The user accessing unit 40 of the multimedia application processor 1 may includes a multimedia accelerator 41 connected to an internal bus, an audio codec '97 (AC '97) controller 42, a color LCD (CLCD) controller 43, a camera controller 44, a keypad controller 45, and a universal asynchronous receiver/transmitter (UART) controller 46.

The multimedia accelerator 41 performs pre-processes and post-processes on input and output video data. In addition, the multimedia accelerator 41 encodes or decodes the video data according to video codec standards.

The AC '97 controller 42 receives and transmits 8-bit or 16-bit sampled audio or voice pulse code modulated (PCM) data and control data from and to the wideband transceiver input/output unit 9 according to the AC '97 standard.

The CLCD controller 43 generates CLCD data, synchronization signals, and clock signals and controls the CLCD so as to output color data information at a high speed on the CLCD that is externally connected.

The camera controller 44 receives a video source of a CCIR-656 format or CMOS sensor from an external and processes the video source. The keypad controller 45 performs scanning of a keypad matrix connected externally so as to reduce a load of scanning function of software in case of implementation of hardware circuits.

The UART controller 46 controls input and output data having a maximum rate of 230.4 kbps and processes the data according to the UART protocol to perform the EIA232 communication.

The network accessing unit 50 of the multimedia application processor 1 may includes a USB OTG controller 51 connected to the internal bus, a USB host controller 52, a synchronous serial interface controller 53, and an Ethernet media access controller (MAC) 54.

The USB OTG controller 51 allows the USP port to perform a device function mode or a host function mode. In addition, the USB OTG controller 51 receives and transmits high-rate serial data from and to the USB OTG port according to the USB 2.0 standard. The USB host controller 52 receives and transmits the high-rate serial data from and to the USB host port according to the USB 2.0 standard.

The synchronous serial interface controller 53 process the data that are input and output serially in synchronization with a clock. The synchronous serial interface controller 53 can process various data according to various types of serial interface standards.

The Ethernet MAC 54 is connected to Ethernet physical-layer devices via a media independent interface (MII) bus. The Ethernet MAC 54 performs an Ethernet MAC function protocol according to the IEEE 802.3 MAC standard.

According to the present invention, the wire/wireless Internet phone terminal using a wideband voice codec directly access the Ethernet or access the Internet via a wireless LAN, so that it is possible to provide a high-quality voice phone function and a multimedia Internet accessing function to the user via the Internet.

In addition, in addition to the aforementioned functions, the wire/wireless Internet phone terminal using an audio codec can be used as a terminal capable of performing various functions by modifying the functions or adding new functions according to the user request. For example, the wire/wireless Internet phone terminal using an audio codec may be provided with a digital multimedia broadcasting (DMB) receiving device so as to be used as a DMB receiving terminal. In addition, the wire/wireless Internet phone terminal using an audio codec may be provided with a global positioning system (GPS) receiving device so as to be used as a GPS receiving terminal. In addition, the wire/wireless Internet phone terminal using an audio codec may be provided with a camera remote control module so as to be used as a video monitoring apparatus.

While the present invention has been shown and described in connection with the exemplary embodiments, it will be apparent to those skilled in the art that modifications and variations can be made without departing from the spirit and scope of the invention as defined by the appended claims.

What is claimed is:

1. A wire/wireless Internet phone terminal using a wideband voice codec, comprising:
a multimedia application processor for including a processor core to perform a protocol according to a wire and wireless interface communication scheme and supporting a wideband voice service;
an Ethernet processing unit for connecting the multimedia application processor to the Ethernet to perform an Ethernet physical-layer function and transforming a power input from the Ethernet to supply a driving power to the multimedia application processor;
a PSTN (public switched telephone network) processing unit for connected to the multimedia application processor and a PSTN to emulate a telephone function; and
a wireless processing unit for connecting the multimedia application processor to an AP (access point) in a wireless manner.

2. The wire/wireless Internet phone terminal of claim 1, wherein the Ethernet processing unit comprises:
an Ethernet physical-layer processing unit for performing the Ethernet physical-layer function by connecting the multimedia application processor to the Ethernet; and
an Ethernet power supply unit for connected to the Ethernet to transform the power inputted from the Ethernet and supplying the power to the multimedia application processor as the driving power.

3. The wire/wireless Internet phone terminal of claim 1, wherein the wireless processing unit comprises:
a USB (universal serial bus) host accessing unit for connected to the multimedia application processor and a USB port to perform a host accessing function of a USB apparatus; and
a wireless access module for connected to the USB host port to perform an AP accessing function in a wireless manner.

4. The wire/wireless Internet phone terminal of claim 1, further comprising a wideband transceiver input/output unit for connected to the multimedia application processor to perform an input and output function of an wideband transceiver.

5. The wire/wireless Internet phone terminal of claim 4, wherein the wideband transceiver input/output unit is constructed with a microphone, a speaker, and a transceiver which inputs and outputs a voice signal in a wideband of 50 Hz to 7 kHz without attenuation.

6. The wire/wireless Internet phone terminal of claim 1, further comprising at least one of:
an EIA232 accessing unit for connected to the multimedia application processor to access a terminal for debugging;
a USB OTG (on-the-go) accessing unit for connected to the multimedia application processor and a USB OTG port to access an USB OTG device;
a JTAG (joint test action group) accessing unit for connected to the multimedia application processor to connect the multimedia application processor to other debugging apparatuses;
a reset unit for providing a reset signal required for the multimedia application processor;
a clock unit for providing a clock signal required for the multimedia application processor;
a memory unit for connected to the multimedia application processor to store a start program, a terminal apparatus operating program, a user data, and a plurality of application programs;
a camera input unit for connected to the multimedia application processor to receive an input of video information from a user;
a CLCD (color LCD) output unit for connected to the multimedia application processor to output a video and information required for the user;
a TV output controller for connected to the multimedia application processor to output a video and information required for the user on a TV; and
a keypad input unit for connected to the multimedia application processor to receive an input of control information from the user.

7. The wire/wireless Internet phone terminal of claim 1, wherein the multimedia application processor comprises:
a processor core unit for including an ARM core to perform a function of controlling the wire/wireless Internet phone terminal using the wideband voice codec;
a user accessing unit for performing an input and output function for the user; and
a network accessing unit for performing a function of connecting to a network.

8. The wire/wireless Internet phone terminal of claim 7, wherein the processor core unit comprises:
a reset controller for controlling a reset signal to be connected to an internal bus connected to the ARM core;
a clock controller for controlling a clock signal;
a memory interface controller for performing an accessing function of accessing an external memory;
a DMA (direct memory access) controller for controlling data reception and transmission between controllers and memories without interruption of a processor;
an interrupt controller for processing an interrupt;
a WD (watch dog) timer for generating the interrupt in a predetermined time period;
a general timer for receiving an input of a reference clock and generating a suitable timing signal at a predetermined time;
an RTC (real-time clock) for counting a clock of 1 Hz in a second unit to calculate minute, hour, day, month, and year;
a bus controller for connecting a data signal, an address signal, and a control signal to one of multiple buses in accordance with a timing of each bus; and
a bus matrix switch for performing high-speed bus switching between multiple matter buses and multiple slave buses.

9. The wire/wireless Internet phone terminal of claim 8, wherein the user accessing unit comprises:
an AC (audio codec) '97 controller for connected to the internal bus to receive and transmit 8-bit or 16-bit sampled voice or audio PCM (pulse code modulated) data;
a CLCD controller for generating and controlling a CLCD data, a synchronization data, and a clock signal;
a camera controller for receiving an input of a video source in a CCIR656 (international radio consultative committee 656) format and a CMOS (complementary metal oxide semiconductor) image sensor from an external and processing the video source;
a keypad controller for performing scanning of a keypad matrix connected externally;
an UART (universal asynchronous receiver/transmitter) controller for controlling asynchronous input and output data; and
a multimedia accelerator for performing pre-processes and post-processes on input and output image data and encoding or decoding the video data according to a video codec standard.

10. The wire/wireless Internet phone terminal of claim 8, wherein the network accessing unit comprises:
an USB OTG controller for connected to the internal bus to process a date which accesses the USB OTG port;
an USB host controller for processing a data which accesses the USB host port;
an SSI (synchronous serial interface) controller for processing a data which is inputted and outputted in series by synchronization with a clock; and
an Ethernet MAC (media access controller) for performing an Ethernet MAC function.
